(19) United States
(12) Patent Application Publication
(10) Pub. No.: US 2025/0274176 A1
(43) Pub. Date: Aug. 28, 2025

(54) PATHLOSS ESTIMATION CONSIDERATIONS FOR IOT DEVICES

(71) Applicant: QUALCOMM Incorporated, San Diego, CA (US)

(72) Inventors: Ahmed ELSHAFIE, San Diego, CA (US); Yuchul KIM, San Diego, CA (US); Zhikun WU, Beijing (CN); Huilin XU, Temecula, CA (US); Linhai HE, San Diego, CA (US); Seyedkianoush HOSSEINI, San Diego, CA (US)

(21) Appl. No.: 18/857,801

(22) PCT Filed: Jun. 22, 2022
(86) PCT No.: PCT/CN2022/100365

§ 371 Date: Oct. 17, 2024

(51) Int. Cl. H04B 7/06; H04B 17/318; H04L 5/00

(52) U.S. Cl. CPC H04B 7/0617; H04B 17/318; H04L 5/0051

(57) ABSTRACT

A first wireless device may transmit, and the second wireless device may receive, from the first wireless device or one or more backscatter IoT devices, a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals may correspond to at least one respective backscatter IoT device. The second wireless device may generate a pathloss estimation report including a plurality of pathloss measurements. Each backscatter IoT device in the one or more backscatter IoT devices may correspond to at least one respective first pathloss measurement in the plurality of pathloss measurements.

### TECHNICAL FIELD

The present disclosure relates generally to communication systems, and more particularly, to pathloss estimation in a wireless communication system where one or more backscatter devices are present.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first wireless device (e.g., a user equipment (UE) or a base station). The first wireless device may identify one or more backscatter Internet of Things (IoT) devices. Each backscatter IoT device in the one or more backscatter IoT devices may be associated with a respective device direction. The first wireless device may transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent.

In an aspect of the disclosure, a method, a computer-readable medium, and an apparatus are provided. The apparatus may be a second wireless device (e.g., a UE or a base station). The second wireless device may receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The second wireless device may generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements.

In an aspect of the disclosure, a method, a computer-readable medium, and an apparatus are provided. The apparatus may be an IoT device (e.g., a backscatter IoT device). The IoT device may receive an indication of a configuration for second pathloss estimation from a wireless device. The IoT device may receive at least one set of second reference signals for the second pathloss estimation from the wireless device. The IoT device may transmit a second pathloss estimation report to the wireless device based on the at least one set of second reference signals. The second pathloss estimation report may include a second pathloss measurement of a second pathloss between the wireless device and the IoT device.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example diagram illustrating operations of a backscatter device.

FIG. 5 is a diagram illustrating multiple sets of reference signals used to measure the pathloss between two devices where one or more backscatter IoT devices may be present according to one or more aspects.

FIG. 6 is a flow diagram of a method of wireless communication according to one or more aspects.

FIG. 7 is a flow diagram of a method of wireless communication according to one or more aspects.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example IoT device.

### DETAILED DESCRIPTION

The energy harvesting technology may be used at such devices as enhanced reduced capability (eRedCap) devices or passive IoT devices. Energy harvesting technology powered devices may opportunistically harvest energy in the environment (e.g., solar energy, heat, energy from the ambient RF radiation, etc.), and may store the harvested energy in an energy storage component (e.g., a rechargeable battery).

Further, similar to a radio frequency identification (RFID) tag, a passive IoT device using backscatter communication may be a battery-less device that collects energy from ambient RF signals and redirects the collected energy.

A transmitter device may perform power control based on a pathloss between the transmitter device and the receiver device. In general, a single set of reference signals may be sufficient for pathloss estimation when there is a direct path and no additional paths (e.g., backscatter paths created by the presence of backscatter devices) between the transmitter device and the receiver device. When there is more than one path between the transmitter and the receiver (e.g., when one or more backscatter IoT devices are present), a single set of references signals may not be sufficient for the estimation of the pathloss.

In one or more aspects, a first wireless device may identify one or more backscatter IoT devices. Each backscatter IoT device in the one or more backscatter IoT devices may be associated with a respective device direction. The first wireless device may transmit, and the second wireless device may receive, from the first wireless device or one or more backscatter IoT devices, a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The second wireless device may generate a pathloss estimation report including a plurality of pathloss measurements. Each backscatter IoT device in the one or more backscatter IoT devices may correspond to at least one respective first pathloss measurement in the plurality of pathloss measurements. Accordingly, based on the multiple sets of reference signals, the pathloss may be estimated for a transmitter device where one or more backscatter devices are present in the environment. The transmitter device may perform power control for subsequent transmissions based on the pathloss estimation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

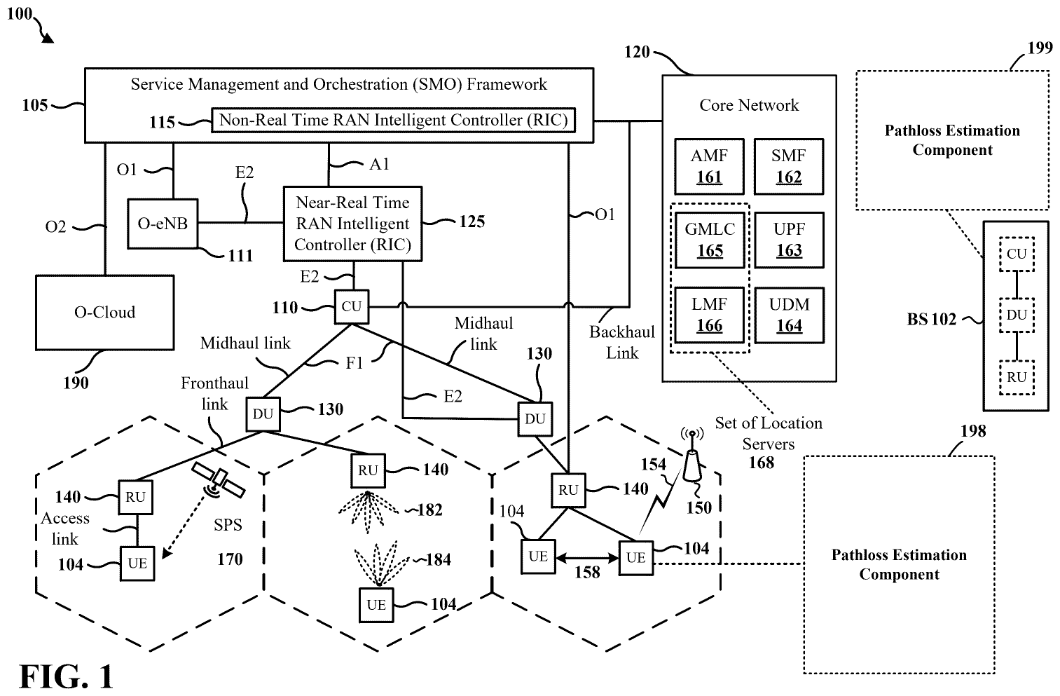

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to Cextend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104, while operating as the device transmitting the reference signals for pathloss estimation, may include a pathloss estimation component 198 that may be configured to identify one or more backscatter IoT devices. Each backscatter IoT device in the one or more backscatter IoT devices may be associated with a respective device direction. The pathloss estimation component 198 may be configured to transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. In certain aspects, the UE 104, while operating as the device receiving the reference signals for pathloss estimation, may include a pathloss estimation component 198 that may be configured to receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The pathloss estimation component 198 may be configured to generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements.

In certain aspects, the base station 102, while operating as the device transmitting the reference signals for pathloss estimation, may include a pathloss estimation component 199 that may be configured to identify one or more backscatter IoT devices. Each backscatter IoT device in the one or more backscatter IoT devices may be associated with a respective device direction. The pathloss estimation component 199 may be configured to transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. In certain aspects, the base station 102, while operating as the device receiving the reference signals for pathloss estimation, may include a pathloss estimation component 199 that may be configured to receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The pathloss estimation component 199 may be configured to generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements. Although the following description may be focused on 5G NR, the concepts described herein may be applicable to other similar areas, such as LTE, LTE-A, CDMA, GSM, and other wireless technologies.

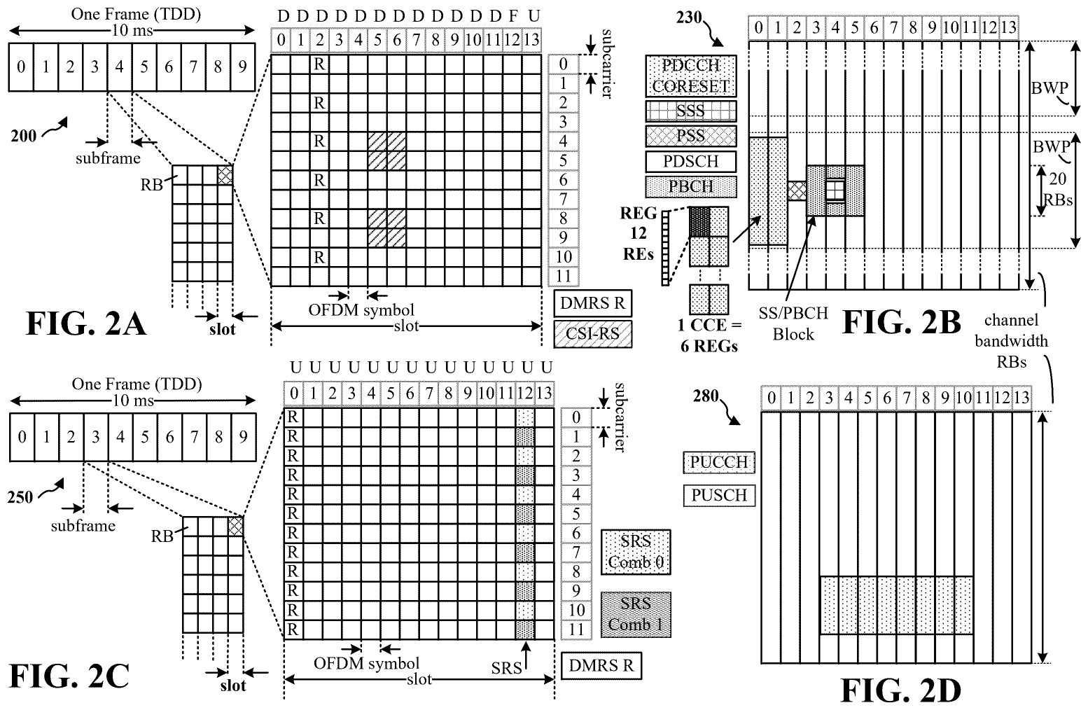

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

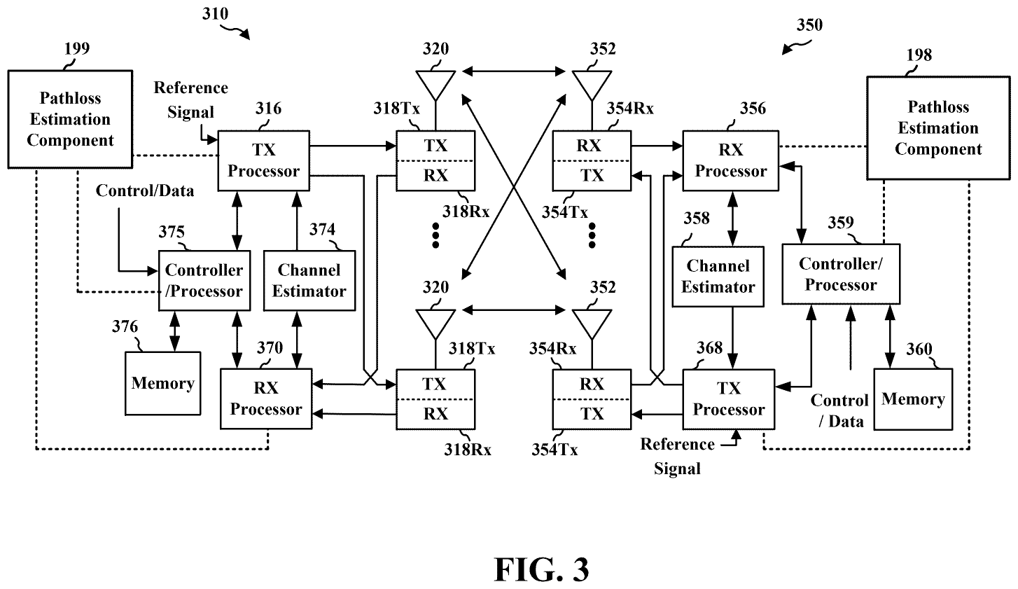

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the pathloss estimation component 198 of FIG. 1.

At least one of the TX processor 316, the RX processor 370, and the controller/processor 375 may be configured to perform aspects in connection with the pathloss estimation component 199 of FIG. 1.

The energy harvesting technology may be used at such devices as eRedCap devices or passive IoT devices. Energy harvesting technology powered devices may opportunistically harvest energy in the environment (e.g., solar energy, heat, energy from the ambient RF radiation, etc.), and may store the harvested energy in an energy storage component (e.g., a rechargeable battery). However, a device operating on intermittently available energy harvested from the environment may not sustain long continuous reception/transmission operations.

Further, similar to an RFID tag, a passive IoT device using backscatter communication may be a battery-less device that collects energy from ambient RF signals and redirects the collected energy. Such a passive IoT device may be different from some energy harvesting technology powered devices that may include power consuming RF components such as analog-to-digital converters (ADCs), mixers, and/or oscillators.

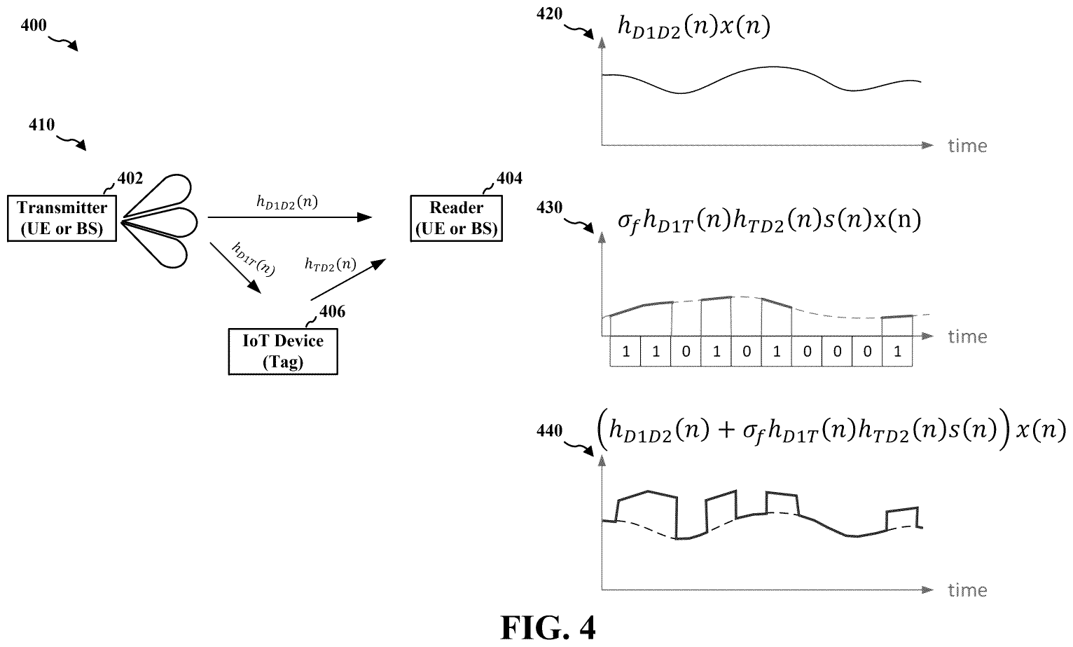

FIG. 4 is an example diagram 400 illustrating operations of a backscatter device. The diagram 410 illustrates an example environment in which a backscatter device, such as a backscatter IoT device 406, may operate. Hereinafter in some configurations, a reference to a backscatter IoT device may also include a reference to an RFID tag. A transmitter device 402 may transmit a radio wave (which may also be referred to hereinafter as a query signal), which may be denoted as x (n). The diagram 420 illustrates the waveform of the radio wave transmitted by the transmitter device 402, which may also be referred to as the direct link signal. The backscatter IoT device 406 may reflect the radio wave transmitted by the transmitter device 402 while simultaneously modulating the information that the backscatter IoT device 406 intends to transmit onto the reflected radio wave. The information bits of the backscatter IoT device 406 may be denoted as s(n)∈{0,1}. In or more configurations, the modulation scheme used by the backscatter IoT device may be amplitude shift keying (ASK). In particular, for example, the backscatter IoT device 406 may switch on the reflection when the backscatter IoT device 406 has an information bit ‘1’ to transmit, and may switch off the reflection when the backscatter IoT device 406 has an information bit ‘0’ to transmit. The diagram 430 illustrates the waveform of the signal reflected by the backscatter IoT device 406, which may also be referred to as the backscatter link signal.

Accordingly, the signal received at the reader device 404 may be:

$$y ( n ) = {h}_{D 1 D 2} ( n ) x ( n ) + {h}_{TD 2} ( n ) {σ}_{f} s ( n ) {h}_{D 1 T} ( n ) x ( n ) + noise$$

When s(n)=0, the backscatter IoT device 406 may switch off the reflection of the incident radio wave. Therefore, when s(n)=0, the reader device 404 may receive the direct link signal: y (n)=h_{D1D2}(n)×(n)+noise. Further, when s(n)=1, the backscatter IoT device 406 may switch on the reflection of the incident radio wave. Therefore, when s(n)=1, the reader device 404 may receive the superposition of both the direct link signal and the backscatter link signal: y (n)=(h_{D1D2}(n)+σ_{f}h_{D1T}(n)h_{TD2}(n)s(n)×(n)+noise, where σ_{f} may denote the reflection coefficient. The diagram 440 illustrates the waveform of the signal received by the reader device 404, i.e., the superposition of both the direct link signal and the backscatter link signal.

In some configurations, the transmitter device 402 and the reader device 404 may be different devices. The corresponding backscatter communication may be referred to as bistatic backscatter communication. In some additional configurations, the transmitter device 402 and the reader device 404 may be a same device. The corresponding backscatter communication may be referred to as monostatic backscatter communication. In different configurations, each of the transmitter device 402 or the reader device 404 may be a UE or a network entity (e.g., a base station).

There may be several types of IoT devices/tags. Examples may include passive IoT devices, semi-passive IoT devices, semi-active IoT devices, and active IoT devices. A passive IoT device may have no energy storage unit. The integrated circuit (IC)) of the passive IoT device may be powered by the incident RF wave power. A semi-passive IoT device may use a battery to power the IC, and may not use the power of the incident RF signal for this purpose. A semi-active IoT device may be similar to the passive IoT device or the semi-passive IoT device, except that the semi-active IoT device may include some active components (e.g., a power amplifier, a low noise amplifier (LNA), or other active components). Further, an active IoT device may also be similar to other types of IoT devices, but may have the ability to transmit and receive using active components (e.g., a regular modem).

For the Uu link between a UE and a base station, if the UE transmits a PUSCH on active UL bandwidth part (BWP) b of carrier f of serving cell c using parameter set configuration with index j and PUSCH power control adjustment state with index l, the UE may determine the PUSCH transmission power P_{PUSCH,b,f,c}(i, j, q_{d}, l) in PUSCH transmission occasion i as:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \}$$

[dBm]
where PL_{b,f,c}(q_{d}) may be a downlink pathloss (i.e., the attenuation of the radio signal as the signal propagates from the transmitter to the receiver) estimate in dB calculated by the UE using reference signal index q_{d} for the active DL BWP, of carrier f of serving cell c, and f_{b,f,c}(i, l) may be the PUSCH power control adjustment state l for active uplink BWP b, of carrier f of serving cell c and PUSCH transmission occasion i. A detailed description of the above formula is provided in Section 7.1.1 of 3GPP TS 38.213.

Further, the sum of transmit power control (TPC) command values in a set Dᵢ of TPC command values that the UE receives between two reference points may be given by the formula:

$${f}_{b , f , c} ( i , l ) = {f}_{b , f , c} ( i - {i}_{0} , l ) + {\sum }_{m = 0}^{\vert {D}_{i} \vert - 1} {δ}_{PUSCH , b , f , c} ( m , l )$$

In some configurations, the pathloss may be calculated based on the reference signal named PUSCH-PathlossReferenceRS (which may be referred to hereinafter as the pathloss reference signal).

Furthermore, for a sidelink between a TX-UE and an RX-UE, an RX-UE may estimate the pathloss based on reference signal received power (RSRP) measurements across multiple PSSCHs, and then may report the estimated pathloss back to the TX-UE. Thereafter, the TX-UE may control the transmission power for the sidelink to the RX-UE based on the estimated pathloss.

The presence of backscatter IoT devices/tags may increase the number of signal paths between a transmitter and a reader. For example, with the presence of one backscatter IoT device, two paths may exist between a transmitter and a reader: one direct path and one backscatter path via the backscatter IoT device. Therefore, the transmission power control at the transmitted may be based on one of the paths that is actually used or both paths. In general, when K (K being a positive integer) backscatter IoT devices are present, K+1 paths may exist between a transmitter and a receiver. Further, the pathloss observed at a receiver may be a function of the composition of the backscatter IoT devices in the K backscatter IoT devices that are or are not backscattering (i.e., which backscatter IoT devices of the K backscatter IoT devices are backscattering). In one or more configurations, multiples sets of references signals may be used to measure the pathloss of the multiple paths present. In general, a single set of reference signals may be sufficient for pathloss estimation when there is a direct path and no additional paths (e.g., backscatter paths created by the presence of backscatter devices) between the transmitter and the receiver. When there is more than one path between the transmitter and the receiver (e.g., when one or more backscatter IoT devices are present), a single set of references signals may not be sufficient for the estimation of the pathloss.

Hereinafter, the device in the pair of devices (for which the pathloss is estimated) that transmits the reference signals for pathloss estimation may be referred to as the first wireless device. The device in the pair of devices that receives the reference signals for pathloss estimation may be referred to as the second wireless device. In different configurations, the process of pathloss estimation between two devices may be configured by either the first wireless device or the second wireless device. For example, if the process of pathloss estimation is configured by the first wireless device, the first wireless device may indicate to the second wireless device the locations (in time-frequency resources) of the sets of reference signals that the first wireless device will transmit, and may transmit the sets of reference signals accordingly. Based on the indication received from the first wireless device, the second wireless device may receive and measure the sets of reference signals. Then, the second wireless device may estimate the pathloss based on the reference signal measurements. Alternatively, the second wireless device may report the reference signal measurements back to the first wireless device, and the first wireless device may perform the pathloss estimation based on the reference signal measurements.

On the other hand, if the process of pathloss estimation is configured by the second wireless device, the second wireless device may indicate to the first wireless device the requested locations (in time-frequency resources) of the sets of reference signals. The first wireless device may then transmit the sets of reference signals based on the indication received from the second wireless device. Subsequent operations for deriving the estimated pathloss may be similar to the corresponding operations performed in the scenario where the process of pathloss estimation is configured by the first wireless device, as described above.

In some additional configurations, the process of pathloss estimation may be configured by another device that is neither the first wireless device or the second wireless device. For example, when both the first wireless device and the second wireless device are UEs, the process of pathloss estimation may be configured by a base station, a controlling network unit, or a controlling (e.g., primary or programmable logic controller) UE. In particular, the device that configures the process of pathloss estimation may transmit the configuration to the first wireless device and the second wireless device. The configuration may include an indication of the locations (in time-frequency resources) of the sets of reference signals. The first wireless device may then transmit the sets of reference signals based on the received configuration. Subsequent operations for deriving the estimated pathloss may be similar to the corresponding operations performed in the scenarios described above.

In one or more configurations, assuming the presence of K backscatter IoT devices, at least K+1 sets of reference signals may be configured for the measurement of the pathloss between the first wireless device and the second wireless device. Each set of reference signals may be used to measure the pathloss associated with backscattering by at least one backscatter IoT device or the pathloss associated with the direct path (i.e., the path not associated with any backscatter IoT device). Therefore, each reference signal measurement may provide some information about the pathloss. In some configurations, each set of reference signals may be associated with an identifier (ID). Therefore, each ID (also referred to as a reference signal ID or reference signal set ID) may be associated with, and may be used to identify, the pathloss associated with a respective path.

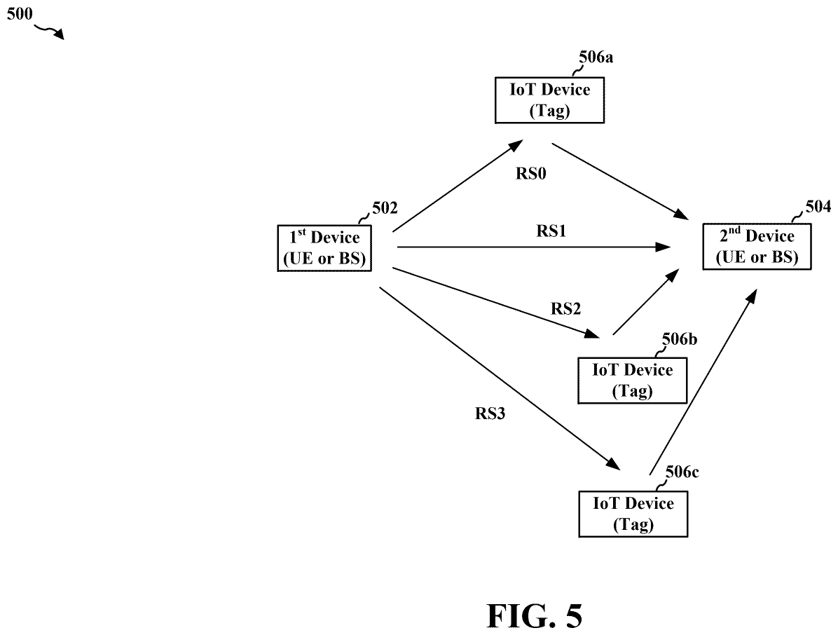

FIG. 5 is a diagram 500 illustrating multiple sets of reference signals used to measure the pathloss between two devices where one or more backscatter IoT devices may be present according to one or more aspects. As shown, 3 backscatter IoT devices 506a, 506b, and 506c may be present. Accordingly, in one configuration, 4 (=3+1) sets of reference signals may be used in the estimation of the pathloss between the first wireless device 502 and the second wireless device 504. The 4 sets of reference signals may be associated with IDs RS0, RS1, RS2, and RS3. In particular, the first wireless device may transmit a set of reference signals with the ID RS0 (or simply, RS0) toward the backscatter IoT device 506a. The backscatter IoT device 506a may reflect RS0 by backscattering. Accordingly, measurement by the second wireless device 504 of RS0 may provide information about the pathloss associated with the backscatter path via the backscatter IoT device 506a. RS2 and RS3 may similarly be used to help estimate the pathloss associated with the backscatter paths via the backscatter IoT devices 506b and 506c, respectively. Moreover, the first wireless device 502 may transmit RS1 to the second wireless device 504 via a direct path not associated with any backscatter IoT device. Therefore, RS1 may be used to help estimate the pathloss associated with the direct path between the first wireless device 502 and the second wireless device 504.

In one or more configurations, for at least one set of reference signals, the second wireless device may report an average measurement across the set of reference signals to the first wireless device. For example, the second wireless device may report an average RSRP measurement for a particular set of reference signals to the first wireless device. In addition to or in lieu of the RSRP, the second wireless device may also report other reference signal measurements such as the reference signal received quality (RSRQ) or the signal-plus-interference-to-noise ratio (SINR) (e.g., an average RSRQ measurement or an average SINR measurement) to the first wireless device. In some configurations, the second wireless device may report reference signal measurements to the first wireless device per the request of the first wireless device based on an indication received from the first wireless device. In one or more configurations, the averaging calculation for deriving an average reference signal measurement may be associated with or based on one or more predefined parameters or filtering coefficients. For example, a filtered RSRP may be calculated as filtered RSRP (at current time)=α*filtered RSRP (previous time)+(1−α)*instantaneous RSRP (at current time). In other examples, a filtered RSRP may be calculated as filtered RSRP=Σⱼ₌₁^{N}βⱼRSRPⱼ, where RSRPⱼ is the RSRP measured at occasion/measurement j∈{1, . . . , N}, N is the number of occasions/measurements, and βⱼ∈{0,1} is the filtering coefficient at occasion/measurement j. Therefore, if

$${β}_{j} = \frac{1}{N} ,$$

the filtered RSRP may be equal to the average of the RSRP measurements. In additional configurations, if the RSRQ or SINR measurements are used, the average/filtered RSRQ or SINR may be calculated similarly.

In one or more configurations, after the pathloss estimation has been obtained, because a reference signal set ID may be associated with the pathloss associated with a particular path (e.g., a backscatter path via at least one particular backscatter IoT device), as explained above, the transmitter device (e.g., when transmitting a query signal to a particular backscatter IoT device) may perform transmit power control based on a particular reference signal set ID (or may use a power control state associated with the reference signal set ID) based on a request from the reader device.

In one or more configurations, either the first wireless device or the second wireless device may initiate a pathloss estimation update. Accordingly, new reference signal measurements may be obtained and the pathloss estimation may be updated.

In one or more configurations, if the transmitter device knows the identities of active backscatter IoT devices associated with a particular set of reference signals (which may be associated with a reference signal set ID), the transmitter device may perform transmit power control based on the reference signal measurements associated with the set of reference signals when the transmitter device interacts with the same backscatter IoT device(s) (e.g., when the transmitter device transmits a query signal (e.g., to assist in the reading from the backscatter IoT device(s) by another reader device) or another signal to the backscatter IoT device(s)).

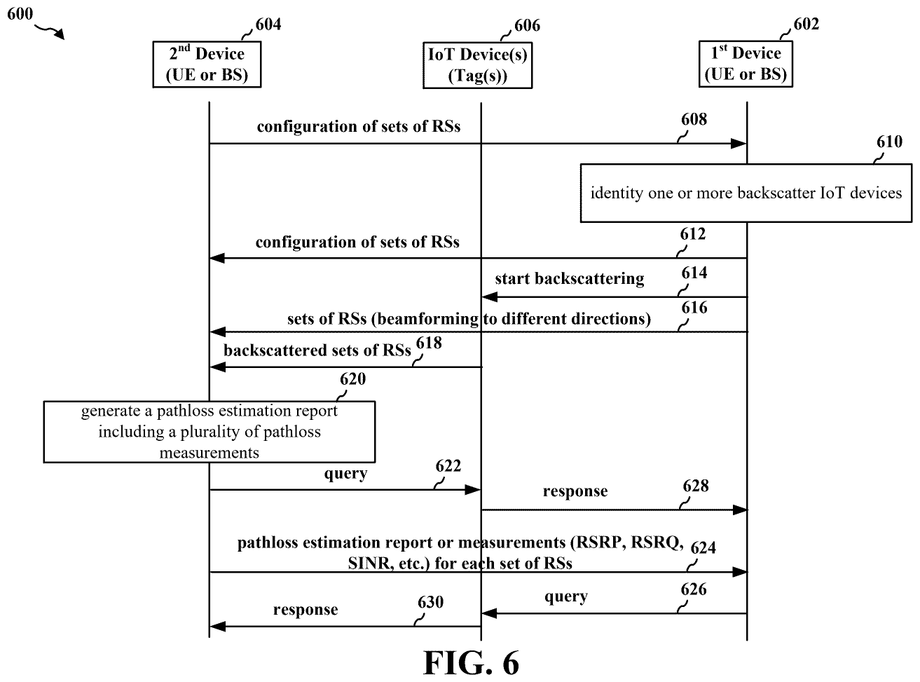

FIG. 6 is a flow diagram of a method 600 of wireless communication according to one or more aspects. If the process of pathloss estimation is configured by the second wireless device 604, at 608, the first wireless device 602 may receive, from a second wireless device 604, an indication of a configuration for the pathloss estimation. The configuration of the pathloss estimation may include locations of sets of reference signals.

At 610, the first wireless device 602 may identify one or more backscatter IoT devices 606. Each backscatter IoT device in the one or more backscatter IoT devices 606 may be associated with a respective device direction.

If the process of pathloss estimation is configured by the first wireless device 602, at 612, the second wireless device 604 may receive, from the first wireless device 602, an indication of a configuration for the pathloss estimation. The configuration of the pathloss estimation may include locations of sets of reference signals.

If the process of pathloss estimation is configured by another device (not shown) (e.g., a base station) other than the first wireless device 602 or the second wireless device 604, the first wireless device 602 and the second wireless device 604 may receive an indication of a configuration for the pathloss estimation from the device configuring the process of pathloss estimation. The configuration of the pathloss estimation may include locations of sets of reference signals.

At 614, the first wireless device 602 may transmit a signal to the one or more backscatter IoT devices 606 so that the one or more backscatter IoT devices 606 may begin backscattering the signals transmitted by the first wireless device 602.

At 616, the first wireless device 602 may transmit, and the second wireless device 604 may receive via direct paths, a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices 606. Each first set of reference signals in the at least one first set of reference signals may correspond to at least one respective backscatter IoT device in the one or more backscatter IoT devices 606 based on the signal direction of the first set of reference signals and the device direction of the at least one respective backscatter IoT device being consistent. In other words, when transmitting a set of reference signals, the first wireless device 602 may beamform toward the at least one respective backscatter IoT device associated with the set of reference signals. In some configurations, the plurality of sets of reference signals may further include at least one second set of reference signals not corresponding to any backscatter IoT device in the one or more backscatter IoT devices.

In one or more configurations, each set of reference signals in the plurality of sets of reference signals 616 may be associated with a respective reference signal set ID.

At 618, the one or more backscatter IoT devices 606 may backscatter the at least one first set of reference signals toward the second wireless device 604. In particular, each backscatter IoT device 606 in the one or more backscatter IoT devices 606 may backscatter the respective set of reference signals associated with the backscatter IoT device 606. Accordingly, the second wireless device 604 may receive, via backscatter paths, the at least one first set of reference signals.

At 620, the second wireless device 604 may generate a pathloss estimation report including a plurality of pathloss measurements based on the plurality of sets of reference signals received at 616 and 618. Each backscatter IoT device in the one or more backscatter IoT devices 606 may correspond to at least one respective first pathloss measurement in the plurality of pathloss measurements. The plurality of pathloss measurements may further include at least one second pathloss measurement not corresponding to any backscatter IoT device in the one or more backscatter IoT devices 606.

In some configurations, if the second wireless device 604 is a transmitter device that transmits a query signal and path reciprocity is assumed, at 622, the second wireless device 604 may transmit a query signal to a first backscatter IoT device in the one or more backscatter IoT devices 606 based on the corresponding at least one first pathloss measurement associated with the first backscatter IoT device. In particular, the second wireless device 604 may perform transmit power control based on the corresponding pathloss measurement.

At 628, the first wireless device 602, operating as the reader device, may receive a response from the first backscatter IoT device in the one or more backscatter IoT devices 606. The response 628 may be based on the query signal 622 from the second wireless device 604.

In some configurations, at 624, the second wireless device 604 may transmit, to the first wireless device 602, and the first wireless device 602 may receive, from the second wireless device 604, the pathloss estimation report. Each backscatter IoT device in the one or more backscatter IoT devices 606 may correspond to at least one respective first pathloss measurement in the plurality of pathloss measurements. The plurality of pathloss measurements may further include at least one second pathloss measurement not corresponding to any backscatter IoT device in the one or more backscatter IoT devices 606.

In some additional configurations, at 624, the second wireless device 604 may transmit, to the first wireless device 602, and the first wireless device 602 may receive, from a second wireless device 604, a plurality of reference signal measurement results. Each reference signal measurement result may correspond to a respective set of reference signals in the plurality of sets of reference signals.

In one or more configurations, each reference signal measurement result in the plurality of reference signal measurement results may include at least one of an RSRP, an RSRQ, or an SINR. In one or more configurations, each reference signal measurement result may be an averaged result over the respective set of reference signals.

In some configurations, if the first wireless device 602 is a transmitter device that transmits a query signal, at 626, the first wireless device 602 may transmit a query signal to a first backscatter IoT device in the one or more backscatter IoT devices 606 based on the at least one respective first pathloss measurement corresponding to the first backscatter IoT device. In particular, the first wireless device 602 may perform transmit power control based on the corresponding pathloss measurement.

At 630, the second wireless device 604, operating as the reader device, may receive a response from the first backscatter IoT device in the one or more backscatter IoT devices 606. The response 630 may be based on the query signal 626 from the first wireless device 602.

In one or more configurations, a backscatter IoT device may include a command mode, where the backscatter IoT device may not backscatter while in the command mode. The command mode may be used to measure the pathloss between a first wireless device and the backscatter IoT device. In particular, the first wireless device may transmit one or more reference signals to the backscatter IoT device while the backscatter IoT device is in the command mode. In one configuration, the backscatter IoT device may measure an energy metric of the one or more reference signals from the first wireless device. The pathloss between the first wireless device and the backscatter IoT device may be derived based on the measured energy metric. In another configuration, if the backscatter IoT device is capable, the backscatter IoT device may measure one or more of an RSRP, an RSRQ, or an SINR associated with the one or more reference signals from the first wireless device.

In one or more configurations, the reference signals used by the first wireless device for the estimation of the pathloss between the first wireless device and the backscatter IoT device may be different from the sets of reference signals used by the first wireless device for the estimation of the pathloss between the first wireless device and the second wireless device.

In one or more configurations, the backscatter IoT device may be equipped with a circuit or a hardware component dedicated to pathloss estimation. The circuit/hardware component may be off while the backscatter IoT device is in the regular backscatter data transmission mode. When the pathloss is to be estimated, the first wireless device may transmit an indication to the backscatter IoT device to instruct the backscatter IoT device to switch on the pathloss estimation circuit/hardware component. Switching on the pathloss estimation circuit/hardware component may place the backscatter IoT device in a different mode from the regular backscatter data transmission mode. For example, when the pathloss estimation circuit/hardware component is switched on, the backscatter IoT device may respond, when queried, not with regular data, but with an indication of the estimated pathloss.

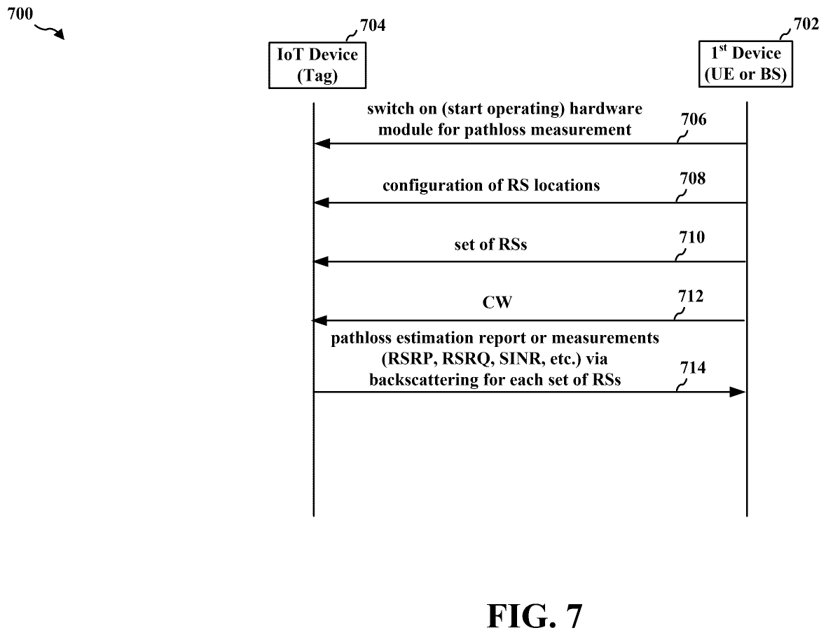

FIG. 7 is a flow diagram of a method 700 of wireless communication according to one or more aspects. At 706, to configure the backscatter IoT device 704 for the estimation of the pathloss between the first wireless device 702 and the backscatter IoT device 704, the first wireless device 702 may place the backscatter IoT device 704 in a command mode. In one or more configurations, the first wireless device 702 may transmit an indication to the backscatter IoT device 704 to instruct the backscatter IoT device 704 to switch on a pathloss estimation circuit/hardware component.

At 708, the first wireless device 702 may configure the backscatter IoT device 704 for the pathloss estimation. For example, the first wireless device 702 may provide an indication of the locations of reference signals for the pathloss estimation to the backscatter IoT device 704.

At 710, the first wireless device 702 may transmit, to the backscatter IoT device 704, and the backscatter IoT device 704 may receive, from the first wireless device 702, one or more reference signals for the pathloss estimation.

At 712, the first wireless device 702 may transmit, to the backscatter IoT device 704, and the backscatter IoT device 704 may receive, from the first wireless device 702, a continuous wave (CW).

At 714, the backscatter IoT device 704 may transmit, to the first wireless device 702, and the first wireless device 702 may receive, from the backscatter IoT device 704, a pathloss estimation report based on the one or more reference signals 710. The backscatter IoT device 704 may transmit the pathloss estimation report in response to the CW 712. In some examples, the backscatter IoT device 704 may be at least partially powered by the CW 712. The pathloss estimation report may include a pathloss measurement of a pathloss between the first wireless device 702 and the backscatter IoT device 704.

In an additional configuration, at 714, the backscatter IoT device 704 may transmit, to the first wireless device 702, and the first wireless device 702 may receive, from the backscatter IoT device 704, a reference signal measurement result (e.g., an RSRP, an RSRQ, an SINR, etc.) based on the one or more reference signals 710.

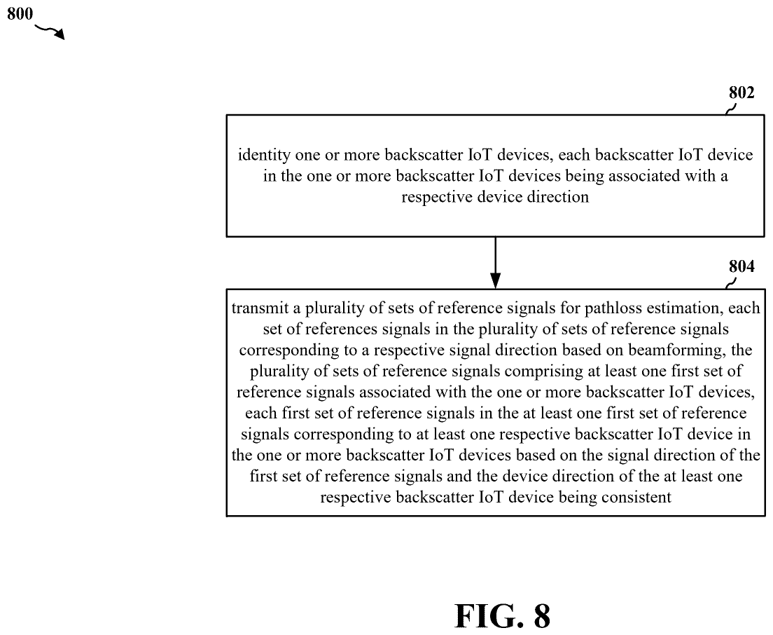

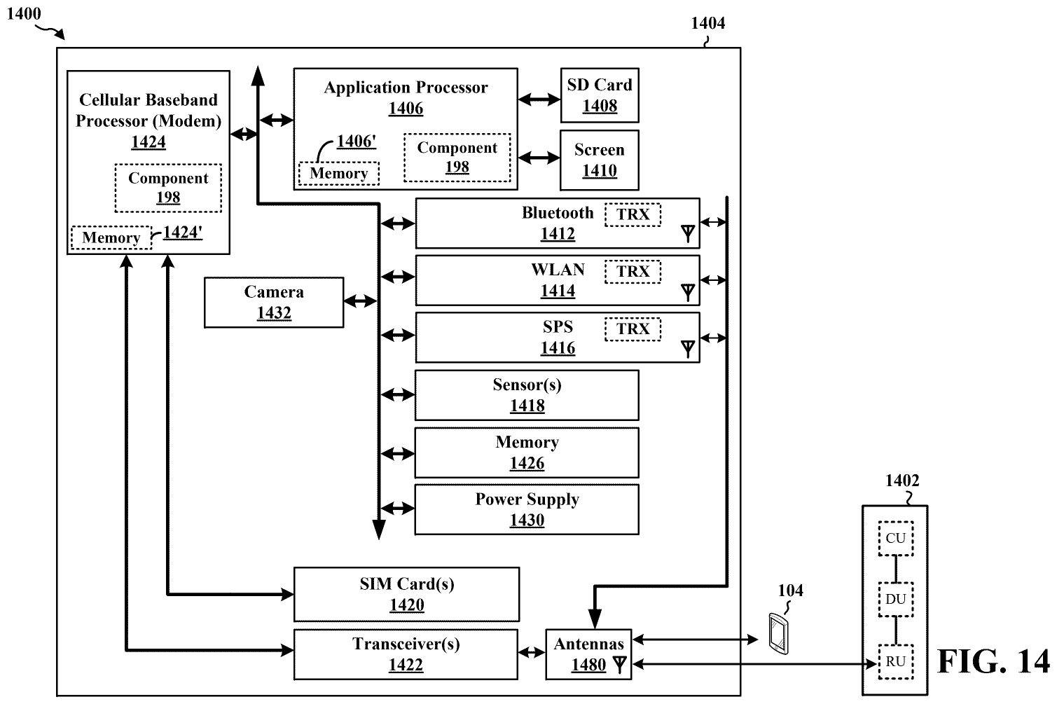

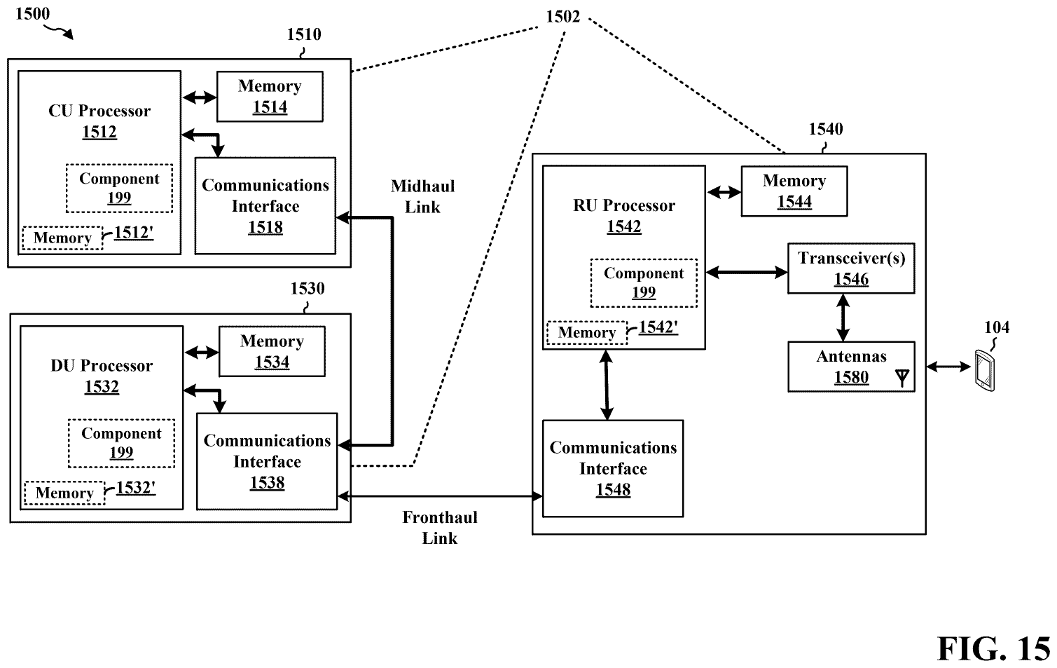

FIG. 8 is a flowchart 800 of a method of wireless communication. The method may be performed by a first wireless device (e.g., the first wireless device 502/602/702; the UE 104/350; the apparatus 1404; the base station 102; the network entity 1402). At 802, the first wireless device may identify one or more backscatter IoT devices. Each backscatter IoT device in the one or more backscatter IoT devices may be associated with a respective device direction. For example, 802 may be performed by the component 198 in FIG. 14 or the component 199 in FIG. 15. Referring to FIG. 6, at 610, the first wireless device 602 may identify one or more backscatter IoT devices 606.

At 804, the first wireless device may transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. For example, 804 may be performed by the component 198 in FIG. 14 or the component 199 in FIG. 15. Referring to FIG. 6, at 616, the first wireless device 602 may transmit a plurality of sets of reference signals for pathloss estimation.

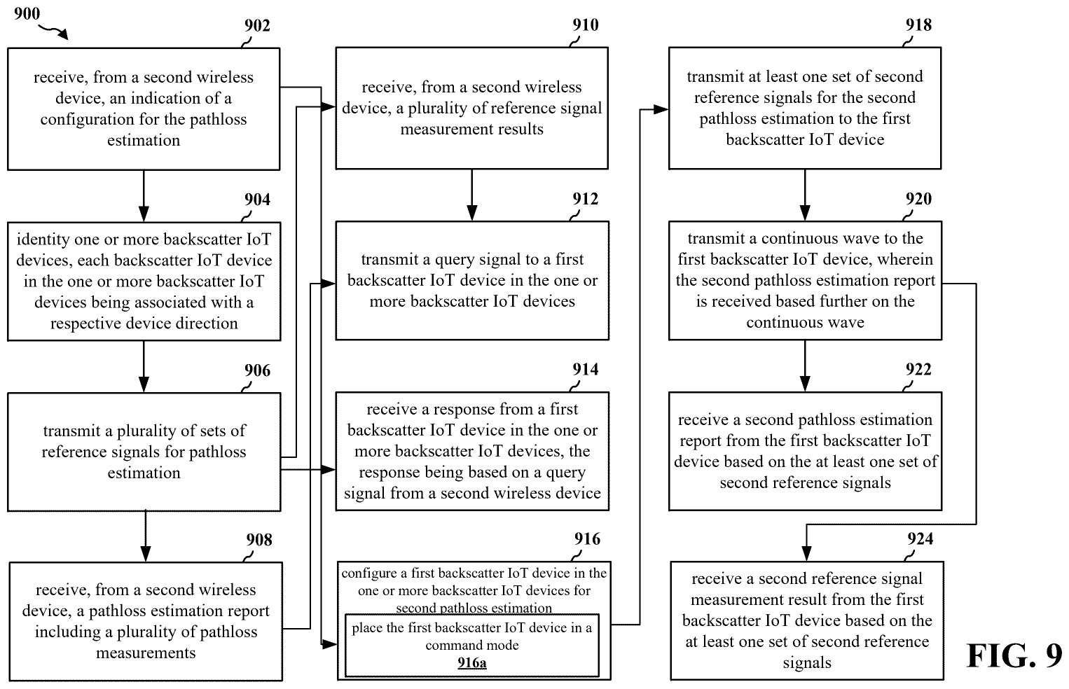

FIG. 9 is a flowchart 900 of a method of wireless communication. The method may be performed by a first wireless device (e.g., the first wireless device 502/602/702; the UE 104/350; the apparatus 1404; the base station 102; the network entity 1402). At 904, the first wireless device may identify one or more backscatter IoT devices. Each backscatter IoT device in the one or more backscatter IoT devices may be associated with a respective device direction. For example, 904 may be performed by the component 198 in FIG. 14 or the component 199 in FIG. 15. Referring to FIG. 6, at 610, the first wireless device 602 may identify one or more backscatter IoT devices 606.

At 906, the first wireless device may transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. For example, 906 may be performed by the component 198 in FIG. 14 or the component 199 in FIG. 15. Referring to FIG. 6, at 616, the first wireless device 602 may transmit a plurality of sets of reference signals for pathloss estimation.

In one configuration, referring to FIG. 6, the plurality of sets of reference signals 616 may further include at least one second set of reference signals not corresponding to any backscatter IoT device in the one or more backscatter IoT devices 606.

In one configuration, at 902, the first wireless device may receive, from a second wireless device, an indication of a configuration for the pathloss estimation. For example, 902 may be performed by the component 198 in FIG. 14 or the component 199 in FIG. 15. Referring to FIG. 6, at 608, the first wireless device 602 may receive, from a second wireless device 604, an indication of a configuration for the pathloss estimation.

In one configuration, at 908, the first wireless device may receive, from a second wireless device, a pathloss estimation report including a plurality of pathloss measurements. Each backscatter IoT device in the one or more backscatter IoT devices may correspond to at least one respective first pathloss measurement in the plurality of pathloss measurements. The plurality of pathloss measurements may further include at least one second pathloss measurement not corresponding to any backscatter IoT device in the one or more backscatter IoT devices. For example, 908 may be performed by the component 198 in FIG. 14 or the component 199 in FIG. 15. Referring to FIG. 6, at 624, the first wireless device 602 may receive, from a second wireless device 604, a pathloss estimation report including a plurality of pathloss measurements.

In one configuration, at 912, the first wireless device may transmit a query signal to a first backscatter IoT device in the one or more backscatter IoT devices based on the at least one respective first pathloss measurement corresponding to the first backscatter IoT device. For example, 912 may be performed by the component 198 in FIG. 14 or the component 199 in FIG. 15. Referring to FIG. 6, at 626, the first wireless device 602 may transmit a query signal to a first backscatter IoT device in the one or more backscatter IoT devices 606 based on the at least one respective first pathloss measurement corresponding to the first backscatter IoT device.

In one configuration, at 910, the first wireless device may receive, from a second wireless device, a plurality of reference signal measurement results. Each reference signal measurement result may correspond to a respective set of reference signals in the plurality of sets of reference signals. For example, 910 may be performed by the component 198 in FIG. 14 or the component 199 in FIG. 15. Referring to FIG. 6, at 624, the first wireless device 602 may receive, from a second wireless device 604, a plurality of reference signal measurement results.

In one configuration, each reference signal measurement result in the plurality of reference signal measurement results may include at least one of an RSRP, an RSRQ, or an SINR.

In one configuration, each reference signal measurement result may be an averaged result over the respective set of reference signals.

In one configuration, at 914, the first wireless device may receive a response from a first backscatter IoT device in the one or more backscatter IoT devices. The response may be based on a query signal from a second wireless device. For example, 914 may be performed by the component 198 in FIG. 14 or the component 199 in FIG. 15. Referring to FIG. 6, at 628, the first wireless device 602 may receive a response from a first backscatter IoT device in the one or more backscatter IoT devices 606.

In one configuration, referring to FIG. 6, each set of reference signals in the plurality of sets of reference signals 616 may be associated with a respective reference signal set ID.

In one configuration, at 916, the first wireless device may configure a first backscatter IoT device in the one or more backscatter IoT devices for second pathloss estimation. For example, 916 may be performed by the component 198 in FIG. 14 or the component 199 in FIG. 15. Referring to FIG. 7, at 708, the first wireless device 702 may configure a first backscatter IoT device 704 in the one or more backscatter IoT devices for second pathloss estimation.

At 918, the first wireless device may transmit at least one set of second reference signals for the second pathloss estimation to the first backscatter IoT device. For example, 918 may be performed by the component 198 in FIG. 14 or the component 199 in FIG. 15. Referring to FIG. 7, at 710, the first wireless device 702 may transmit at least one set of second reference signals for the second pathloss estimation to the first backscatter IoT device 704.

At 922, the first wireless device may receive a second pathloss estimation report from the first backscatter IoT device based on the at least one set of second reference signals. The second pathloss estimation report may include a second pathloss measurement of a second pathloss between the first wireless device and the first backscatter IoT device. For example, 922 may be performed by the component 198 in FIG. 14 or the component 199 in FIG. 15. Referring to FIG. 7, at 714, the first wireless device 702 may receive a second pathloss estimation report from the first backscatter IoT device 704 based on the at least one set of second reference signals 710.

In one configuration, at 920, the first wireless device may transmit a continuous wave to the first backscatter IoT device. The second pathloss estimation report may be received based further on the continuous wave. For example, 920 may be performed by the component 198 in FIG. 14 or the component 199 in FIG. 15. Referring to FIG. 7, at 712, the first wireless device 702 may transmit a continuous wave to the first backscatter IoT device 704.

In one configuration, at 924, the first wireless device may receive a second reference signal measurement result from the first backscatter IoT device based on the at least one set of second reference signals. For example, 924 may be performed by the component 198 in FIG. 14 or the component 199 in FIG. 15. Referring to FIG. 7, at 714, the first wireless device 702 may receive a second reference signal measurement result from the first backscatter IoT device 704 based on the at least one set of second reference signals 710.

In one configuration, to configure the first backscatter IoT device for the second pathloss estimation, at 916a, the first wireless device may place the first backscatter IoT device in a command mode. For example, 916a may be performed by the component 198 in FIG. 14 or the component 199 in FIG. 15. Referring to FIG. 7, at 706, to configure 708 the first backscatter IoT device 704 for the second pathloss estimation, the first wireless device 702 may place the first backscatter IoT device 704 in a command mode.

In one configuration, referring to FIGS. 6 and 7, the first wireless device 602/702 may be a UE or a network entity.

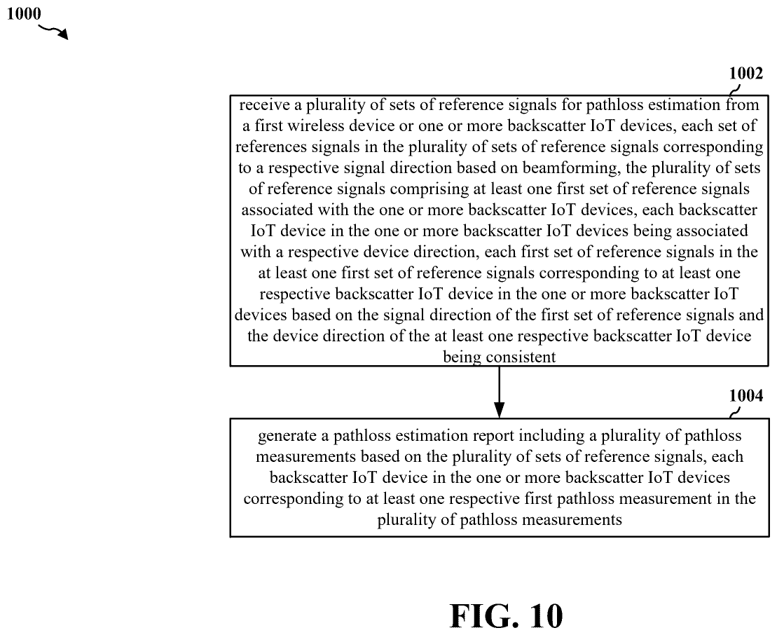

FIG. 10 is a flowchart 1000 of a method of wireless communication. The method may be performed by a second wireless device (e.g., the second wireless device 504/604/704; the UE 104/350; the apparatus 1404; the base station 102; the network entity 1402). At 1002, the second wireless device may receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. For example, 1002 may be performed by the component 198 in FIG. 14 or the component 199 in FIG. 15. Referring to FIGS. 6, at 616 and 618, the second wireless device 604 may receive a plurality of sets of reference signals for pathloss estimation from a first wireless device 602 or one or more backscatter IoT devices 606.

At 1004, the second wireless device may generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements. For example, 1004 may be performed by the component 198 in FIG. 14 or the component 199 in FIG. 15. Referring to FIG. 6, at 620, the second wireless device 604 may generate a pathloss estimation report including a plurality of pathloss measurements based on the plurality of sets of reference signals 616 and 618.

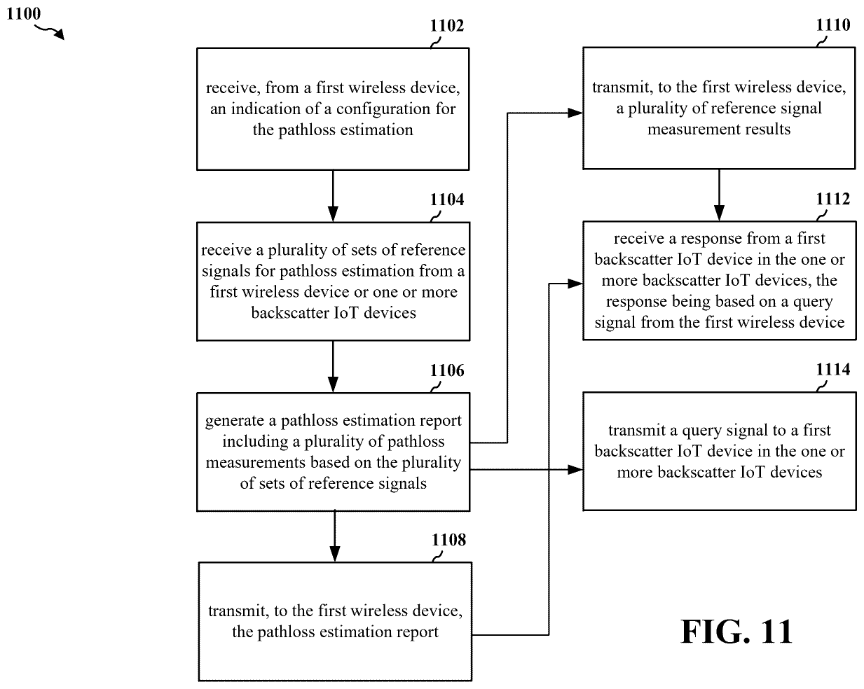

FIG. 11 is a flowchart 1100 of a method of wireless communication. The method may be performed by a second wireless device (e.g., the second wireless device 504/604/704; the UE 104/350; the apparatus 1404; the base station 102; the network entity 1402). At 1104, the second wireless device may receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. For example, 1104 may be performed by the component 198 in FIG. 14 or the component 199 in FIG. 15. Referring to FIGS. 6, at 616 and 618, the second wireless device 604 may receive a plurality of sets of reference signals for pathloss estimation from a first wireless device 602 or one or more backscatter IoT devices 606.

At 1106, the second wireless device may generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements. For example, 1106 may be performed by the component 198 in FIG. 14 or the component 199 in FIG. 15. Referring to FIG. 6, at 620, the second wireless device 604 may generate a pathloss estimation report including a plurality of pathloss measurements based on the plurality of sets of reference signals 616 and 618.

In one configuration, referring to FIG. 6, the plurality of sets of reference signals 616 may further include at least one second set of reference signals not corresponding to any backscatter IoT device in the one or more backscatter IoT devices 606. The plurality of pathloss measurements may further include at least one second pathloss measurement not corresponding to any backscatter IoT device in the one or more backscatter IoT devices 606.

In one configuration, at 1102, the second wireless device may receive, from the first wireless device, an indication of a configuration for the pathloss estimation. For example, 1102 may be performed by the component 198 in FIG. 14 or the component 199 in FIG. 15. Referring to FIG. 6, at 612, the second wireless device 604 may receive, from the first wireless device 602, an indication of a configuration for the pathloss estimation.

In one configuration, at 1108, the second wireless device may transmit, to the first wireless device, the pathloss estimation report. For example, 1108 may be performed by the component 198 in FIG. 14 or the component 199 in FIG. 15. Referring to FIG. 6, at 624, the second wireless device 604 may transmit, to the first wireless device 602, the pathloss estimation report.

In one configuration, at 1114, the second wireless device may transmit a query signal to a first backscatter IoT device in the one or more backscatter IoT devices based on the at least one respective first pathloss measurement corresponding to the first backscatter IoT device. For example, 1114 may be performed by the component 198 in FIG. 14 or the component 199 in FIG. 15. Referring to FIG. 6, at 622, the second wireless device 604 may transmit a query signal to a first backscatter IoT device in the one or more backscatter IoT devices 606 based on the at least one respective first pathloss measurement corresponding to the first backscatter IoT device.

In one configuration, at 1110, the second wireless device may transmit, to the first wireless device, a plurality of reference signal measurement results. Each reference signal measurement result may correspond to a respective set of reference signals in the plurality of sets of reference signals. For example, 1110 may be performed by the component 198 in FIG. 14 or the component 199 in FIG. 15. Referring to FIG. 6, at 624, the second wireless device 604 may transmit, to the first wireless device 602, a plurality of reference signal measurement results.

In one configuration, each reference signal measurement result in the plurality of reference signal measurement results may include at least one of an RSRP, an RSRQ, or an SINR.

In one configuration, each reference signal measurement result may be an averaged result over the respective set of reference signals.

In one configuration, at 1112, the second wireless device may receive a response from a first backscatter IoT device in the one or more backscatter IoT devices. The response may be based on a query signal from the first wireless device. For example, 1112 may be performed by the component 198 in FIG. 14 or the component 199 in FIG. 15. Referring to FIG. 6, at 630, the second wireless device 604 may receive a response from a first backscatter IoT device in the one or more backscatter IoT devices 606.

In one configuration, referring to FIG. 6, the second wireless device 604 may be a UE or a network entity.

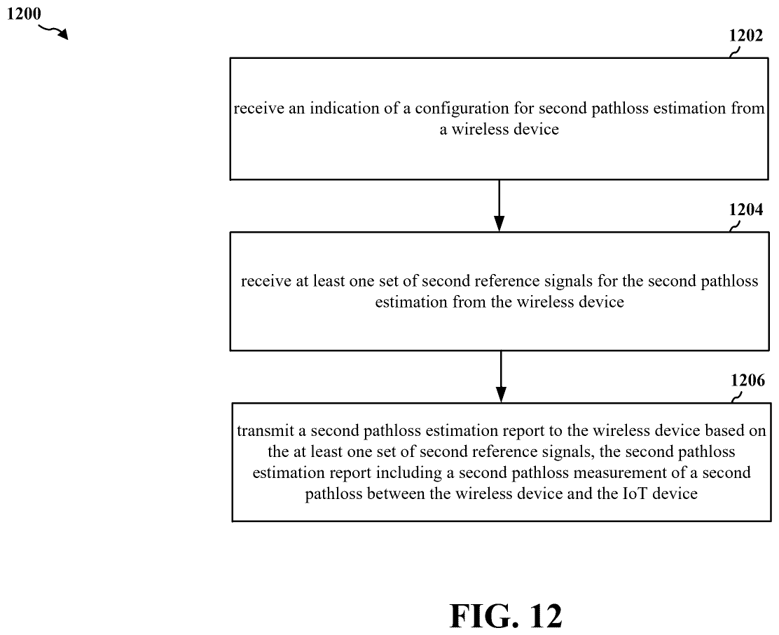

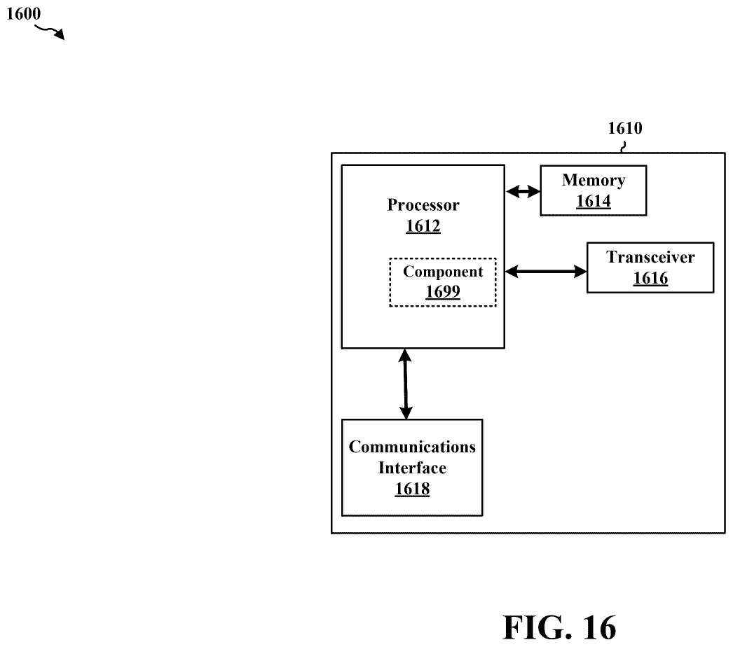

FIG. 12 is a flowchart 1200 of a method of wireless communication. The method may be performed by an IoT device (e.g., the IoT device 506a/506b/506c/704/1610). At 1202, the IoT device may receive an indication of a configuration for second pathloss estimation from a wireless device. For example, 1202 may be performed by the component 1699 in FIG. 16. Referring to FIG. 7, at 708, the IoT device 704 may receive an indication of a configuration for second pathloss estimation from a wireless device 702.

At 1204, the IoT device may receive at least one set of second reference signals for the second pathloss estimation from the wireless device. For example, 1204 may be performed by the component 1699 in FIG. 16. Referring to FIG. 7, at 710, the IoT device 704 may receive at least one set of second reference signals for the second pathloss estimation from the wireless device 702.

At 1206, the IoT device may transmit a second pathloss estimation report to the wireless device based on the at least one set of second reference signals. The second pathloss estimation report may include a second pathloss measurement of a second pathloss between the wireless device and the IoT device. For example, 1206 may be performed by the component 1699 in FIG. 16. Referring to FIG. 7, at 714, the IoT device 704 may transmit a second pathloss estimation report to the wireless device 702 based on the at least one set of second reference signals 710.

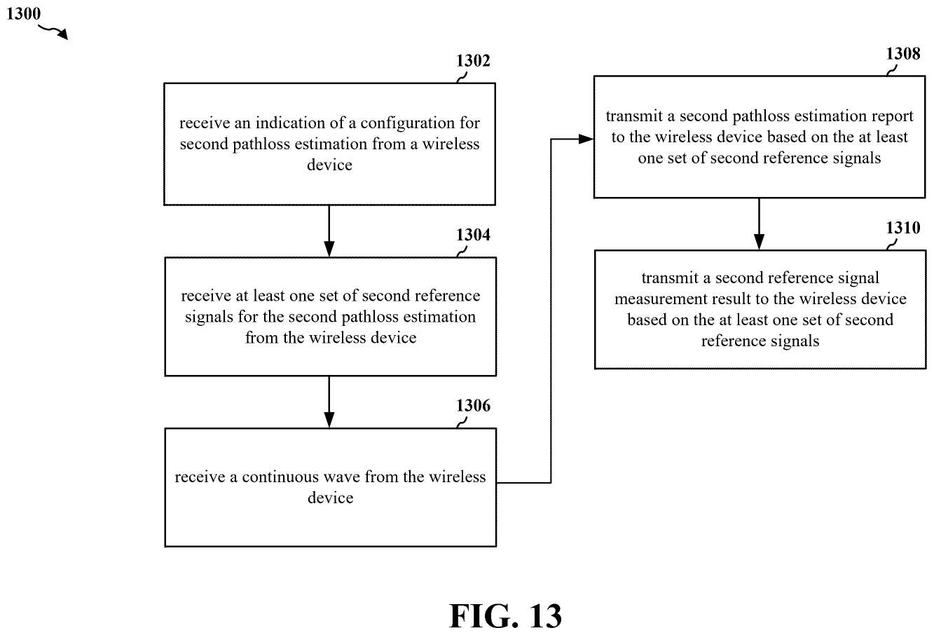

FIG. 13 is a flowchart 1300 of a method of wireless communication. The method may be performed by an IoT device (e.g., the IoT device 506a/506b/506c/704/1610). At 1302, the IoT device may receive an indication of a configuration for second pathloss estimation from a wireless device. For example, 1302 may be performed by the component 1699 in FIG. 16. Referring to FIG. 7, at 708, the IoT device 704 may receive an indication of a configuration for second pathloss estimation from a wireless device 702.

At 1304, the IoT device may receive at least one set of second reference signals for the second pathloss estimation from the wireless device. For example, 1304 may be performed by the component 1699 in FIG. 16. Referring to FIG. 7, at 710, the IoT device 704 may receive at least one set of second reference signals for the second pathloss estimation from the wireless device 702.

At 1308, the IoT device may transmit a second pathloss estimation report to the wireless device based on the at least one set of second reference signals. The second pathloss estimation report may include a second pathloss measurement of a second pathloss between the wireless device and the IoT device. For example, 1308 may be performed by the component 1699 in FIG. 16. Referring to FIG. 7, at 714, the IoT device 704 may transmit a second pathloss estimation report to the wireless device 702 based on the at least one set of second reference signals 710.

In one configuration, at 1306, the IoT device may receive a continuous wave from the wireless device. The second pathloss estimation report may be transmitted based further on the continuous wave. For example, 1306 may be performed by the component 1699 in FIG. 16. Referring to FIG. 7, at 712, the IoT device 704 may receive a continuous wave from the wireless device 702.

In one configuration, at 1310, the IoT device may transmit a second reference signal measurement result to the wireless device based on the at least one set of second reference signals. For example, 1310 may be performed by the component 1699 in FIG. 16. Referring to FIG. 7, at 714, the IoT device 704 may transmit a second reference signal measurement result to the wireless device 702 based on the at least one set of second reference signals 710.

In one configuration, referring to FIG. 7, the configuration 708 for the second pathloss estimation may be associated with a command mode 706 of the IoT device 704.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, if the apparatus 1404 operates as a first wireless device (i.e., the device transmitting the reference signals), the component 198 may be configured to identify one or more backscatter IoT devices. Each backscatter IoT device in the one or more backscatter IoT devices may be associated with a respective device direction. The component 198 may be configured to transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for identifying one or more backscatter IoT devices. Each backscatter IoT device in the one or more backscatter IoT devices may be associated with a respective device direction. The apparatus 1404, and in particular the cellular baseband processor 1424 and/or the application processor 1406, includes means for transmitting a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent.

In one configuration, the plurality of sets of reference signals may further include at least one second set of reference signals not corresponding to any backscatter IoT device in the one or more backscatter IoT devices. In one configuration, the apparatus 1404, and in particular the cellular baseband processor 1424 and/or the application processor 1406, includes means for receiving, from a second wireless device, an indication of a configuration for the pathloss estimation. In one configuration, the apparatus 1404, and in particular the cellular baseband processor 1424 and/or the application processor 1406, includes means for receiving, from a second wireless device, a pathloss estimation report including a plurality of pathloss measurements. Each backscatter IoT device in the one or more backscatter IoT devices may correspond to at least one respective first pathloss measurement in the plurality of pathloss measurements. The plurality of pathloss measurements may further include at least one second pathloss measurement not corresponding to any backscatter IoT device in the one or more backscatter IoT devices. In one configuration, the apparatus 1404, and in particular the cellular baseband processor 1424 and/or the application processor 1406, includes means for transmitting a query signal to a first backscatter IoT device in the one or more backscatter IoT devices based on the at least one respective first pathloss measurement corresponding to the first backscatter IoT device. In one configuration, the apparatus 1404, and in particular the cellular baseband processor 1424 and/or the application processor 1406, includes means for receiving, from a second wireless device, a plurality of reference signal measurement results. Each reference signal measurement result may correspond to a respective set of reference signals in the plurality of sets of reference signals. In one configuration, each reference signal measurement result in the plurality of reference signal measurement results may include at least one of an RSRP, an RSRQ, or an SINR. In one configuration, each reference signal measurement result may be an averaged result over the respective set of reference signals. In one configuration, the apparatus 1404, and in particular the cellular baseband processor 1424 and/or the application processor 1406, includes means for receiving a response from a first backscatter IoT device in the one or more backscatter IoT devices. The response may be based on a query signal from a second wireless device. In one configuration, each set of reference signals in the plurality of sets of reference signals may be associated with a respective reference signal set ID. In one configuration, the apparatus 1404, and in particular the cellular baseband processor 1424 and/or the application processor 1406, includes means for configuring a first backscatter IoT device in the one or more backscatter IoT devices for second pathloss estimation. The apparatus 1404, and in particular the cellular baseband processor 1424 and/or the application processor 1406, includes means for transmitting at least one set of second reference signals for the second pathloss estimation to the first backscatter IoT device. The apparatus 1404, and in particular the cellular baseband processor 1424 and/or the application processor 1406, includes means for receiving a second pathloss estimation report from the first backscatter IoT device based on the at least one set of second reference signals. The second pathloss estimation report may include a second pathloss measurement of a second pathloss between the first wireless device and the first backscatter IoT device. In one configuration, the apparatus 1404, and in particular the cellular baseband processor 1424 and/or the application processor 1406, includes means for transmitting a continuous wave to the first backscatter IoT device. The second pathloss estimation report may be received based further on the continuous wave. In one configuration, the apparatus 1404, and in particular the cellular baseband processor 1424 and/or the application processor 1406, includes means for receiving a second reference signal measurement result from the first backscatter IoT device based on the at least one set of second reference signals. In one configuration, to configure the first backscatter IoT device for the second pathloss estimation, the apparatus 1404, and in particular the cellular baseband processor 1424 and/or the application processor 1406, includes means for placing the first backscatter IoT device in a command mode.

The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, if the apparatus 1404 operates as a second wireless device (i.e., the device receiving the reference signals), the component 198 may be configured to receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The component 198 may be configured to generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for receiving a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The apparatus 1404, and in particular the cellular baseband processor 1424 and/or the application processor 1406, includes means for generating a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements.

In one configuration, the plurality of sets of reference signals may further include at least one second set of reference signals not corresponding to any backscatter IoT device in the one or more backscatter IoT devices. The plurality of pathloss measurements may further include at least one second pathloss measurement not corresponding to any backscatter IoT device in the one or more backscatter IoT devices. In one configuration, the apparatus 1404, and in particular the cellular baseband processor 1424 and/or the application processor 1406, includes means for receiving, from the first wireless device, an indication of a configuration for the pathloss estimation. In one configuration, the apparatus 1404, and in particular the cellular baseband processor 1424 and/or the application processor 1406, includes means for transmitting, to the first wireless device, the pathloss estimation report. In one configuration, the apparatus 1404, and in particular the cellular baseband processor 1424 and/or the application processor 1406, includes means for transmitting a query signal to a first backscatter IoT device in the one or more backscatter IoT devices based on the at least one respective first pathloss measurement corresponding to the first backscatter IoT device. In one configuration, the apparatus 1404, and in particular the cellular baseband processor 1424 and/or the application processor 1406, includes means for transmitting, to the first wireless device, a plurality of reference signal measurement results. Each reference signal measurement result may correspond to a respective set of reference signals in the plurality of sets of reference signals. In one configuration, each reference signal measurement result in the plurality of reference signal measurement results may include at least one of an RSRP, an RSRQ, or an SINR. In one configuration, each reference signal measurement result may be an averaged result over the respective set of reference signals. In one configuration, the apparatus 1404, and in particular the cellular baseband processor 1424 and/or the application processor 1406, includes means for receiving a response from a first backscatter IoT device in the one or more backscatter IoT devices. The response may be based on a query signal from the first wireless device.

The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, if the network entity 1502 operates as a first wireless device (i.e., the device transmitting the reference signals), the component 199 may be configured to identify one or more backscatter IoT devices. Each backscatter IoT device in the one or more backscatter IoT devices may be associated with a respective device direction. The component 199 may be configured to transmit a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for identifying one or more backscatter IoT devices. Each backscatter IoT device in the one or more backscatter IoT devices may be associated with a respective device direction. The network entity 1502 includes means for transmitting a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent.

In one configuration, the plurality of sets of reference signals may further include at least one second set of reference signals not corresponding to any backscatter IoT device in the one or more backscatter IoT devices. In one configuration, the network entity 1502 includes means for receiving, from a second wireless device, an indication of a configuration for the pathloss estimation. In one configuration, the network entity 1502 includes means for receiving, from a second wireless device, a pathloss estimation report including a plurality of pathloss measurements. Each backscatter IoT device in the one or more backscatter IoT devices may correspond to at least one respective first pathloss measurement in the plurality of pathloss measurements. The plurality of pathloss measurements may further include at least one second pathloss measurement not corresponding to any backscatter IoT device in the one or more backscatter IoT devices. In one configuration, the network entity 1502 includes means for transmitting a query signal to a first backscatter IoT device in the one or more backscatter IoT devices based on the at least one respective first pathloss measurement corresponding to the first backscatter IoT device. In one configuration, the network entity 1502 includes means for receiving, from a second wireless device, a plurality of reference signal measurement results. Each reference signal measurement result may correspond to a respective set of reference signals in the plurality of sets of reference signals. In one configuration, each reference signal measurement result in the plurality of reference signal measurement results may include at least one of an RSRP, an RSRQ, or an SINR. In one configuration, each reference signal measurement result may be an averaged result over the respective set of reference signals. In one configuration, the network entity 1502 includes means for receiving a response from a first backscatter IoT device in the one or more backscatter IoT devices. The response may be based on a query signal from a second wireless device. In one configuration, each set of reference signals in the plurality of sets of reference signals may be associated with a respective reference signal set ID. In one configuration, the network entity 1502 includes means for configuring a first backscatter IoT device in the one or more backscatter IoT devices for second pathloss estimation. The network entity 1502 includes means for transmitting at least one set of second reference signals for the second pathloss estimation to the first backscatter IoT device. The network entity 1502 includes means for receiving a second pathloss estimation report from the first backscatter IoT device based on the at least one set of second reference signals. The second pathloss estimation report may include a second pathloss measurement of a second pathloss between the first wireless device and the first backscatter IoT device. In one configuration, the network entity 1502 includes means for transmitting a continuous wave to the first backscatter IoT device. The second pathloss estimation report may be received based further on the continuous wave. In one configuration, the network entity 1502 includes means for receiving a second reference signal measurement result from the first backscatter IoT device based on the at least one set of second reference signals. In one configuration, to configure the first backscatter IoT device for the second pathloss estimation, the network entity 1502 includes means for placing the first backscatter IoT device in a command mode.

The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, if the network entity 1502 operates as a second wireless device (i.e., the device receiving the reference signals), the component 199 may be configured to receive a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The component 199 may be configured to generate a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for receiving a plurality of sets of reference signals for pathloss estimation from a first wireless device or one or more backscatter IoT devices. Each set of references signals in the plurality of sets of reference signals may correspond to a respective signal direction based on beamforming. The plurality of sets of reference signals may include at least one first set of reference signals associated with the one or more backscatter IoT devices. Each backscatter IoT device in the one or more backscatter IoT devices may be associated with a respective device direction. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The network entity 1502 includes means for generating a pathloss estimation report including a plurality of pathloss measurements based on the plurality of sets of reference signals. Each backscatter IoT device in the one or more backscatter IoT devices may correspond to at least one respective first pathloss measurement in the plurality of pathloss measurements.

In one configuration, the plurality of sets of reference signals may further include at least one second set of reference signals not corresponding to any backscatter IoT device in the one or more backscatter IoT devices. The plurality of pathloss measurements may further include at least one second pathloss measurement not corresponding to any backscatter IoT device in the one or more backscatter IoT devices. In one configuration, the network entity 1502 includes means for receiving, from the first wireless device, an indication of a configuration for the pathloss estimation. In one configuration, the network entity 1502 includes means for transmitting, to the first wireless device, the pathloss estimation report. In one configuration, the network entity 1502 includes means for transmitting a query signal to a first backscatter IoT device in the one or more backscatter IoT devices based on the at least one respective first pathloss measurement corresponding to the first backscatter IoT device. In one configuration, the network entity 1502 includes means for transmitting, to the first wireless device, a plurality of reference signal measurement results. Each reference signal measurement result may correspond to a respective set of reference signals in the plurality of sets of reference signals. In one configuration, each reference signal measurement result in the plurality of reference signal measurement results may include at least one of an RSRP, an RSRQ, or an SINR. In one configuration, each reference signal measurement result may be an averaged result over the respective set of reference signals. In one configuration, the network entity 1502 includes means for receiving a response from a first backscatter IoT device in the one or more backscatter IoT devices. The response may be based on a query signal from the first wireless device.

The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 16 is a diagram 1600 illustrating an example of a hardware implementation for an IoT device 1610. The IoT device 1610 may include a processor 1612. In some aspects, the IoT device 1610 may further include memory modules 1614. The IoT device 1610 communicates via the transceiver 1616. The IoT device 1610 may further include a communications interface 1618. The memory modules 1614 may be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 1699 may be configured to receive an indication of a configuration for second pathloss estimation from a wireless device. The component 1699 may be configured to receive at least one set of second reference signals for the second pathloss estimation from the wireless device. The component 1699 may be configured to transmit a second pathloss estimation report to the wireless device based on the at least one set of second reference signals. The second pathloss estimation report may include a second pathloss measurement of a second pathloss between the wireless device and the IoT device. The component 1699 may be one or more hardware components specifically configured to carry out the stated processes/algorithm, implemented by one or more processors configured to perform the stated processes/algorithm, stored within a computer-readable medium for implementation by one or more processors, or some combination thereof. The IoT device 1610 may include a variety of components configured for various functions. In one configuration, the IoT device 1610 includes means for receiving an indication of a configuration for second pathloss estimation from a wireless device. The IoT device 1610 includes means for receiving at least one set of second reference signals for the second pathloss estimation from the wireless device. The IoT device 1610 includes means for transmitting a second pathloss estimation report to the wireless device based on the at least one set of second reference signals. The second pathloss estimation report may include a second pathloss measurement of a second pathloss between the wireless device and the IoT device.

In one configuration, the IoT device 1610 includes means for receiving a continuous wave from the wireless device. The second pathloss estimation report may be transmitted based further on the continuous wave. In one configuration, the IoT device 1610 includes means for transmitting a second reference signal measurement result to the wireless device based on the at least one set of second reference signals. In one configuration, the configuration for the second pathloss estimation may be associated with a command mode of the IoT device.

The means may be the component 1699 of the IoT device 1610 configured to perform the functions recited by the means.

Referring back to FIGS. 4-16, a first wireless device may identify one or more backscatter IoT devices. Each backscatter IoT device in the one or more backscatter IoT devices may be associated with a respective device direction. The first wireless device may transmit, and the second wireless device may receive, from the first wireless device or one or more backscatter IoT devices, a plurality of sets of reference signals for pathloss estimation. Each set of references signals in the plurality of sets of reference signals may correspond to a respective signal direction based on beamforming. The plurality of sets of reference signals may include at least one first set of reference signals associated with the one or more backscatter IoT devices. Each first set of reference signals in the at least one first set of reference signals may correspond to at least one respective backscatter IoT device in the one or more backscatter IoT devices based on the signal direction of the first set of reference signals and the device direction of the at least one respective backscatter IoT device being consistent. The second wireless device may generate a pathloss estimation report including a plurality of pathloss measurements. Each backscatter IoT device in the one or more backscatter IoT devices may correspond to at least one respective first pathloss measurement in the plurality of pathloss measurements. Accordingly, based on the multiple sets of reference signals, the pathloss may be estimated for a transmitter device where one or more backscatter devices are present in the environment. The transmitter device may perform power control for subsequent transmissions based on the pathloss estimation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first wireless device, including identifying one or more backscatter IoT devices, each backscatter IoT device in the one or more backscatter IoT devices being associated with a respective device direction; and transmitting a plurality of sets of reference signals for pathloss estimation, each set of references signals in the plurality of sets of reference signals corresponding to a respective signal direction based on beamforming, the plurality of sets of reference signals including at least one first set of reference signals associated with the one or more backscatter IoT devices, each first set of reference signals in the at least one first set of reference signals corresponding to at least one respective backscatter IoT device in the one or more backscatter IoT devices based on the signal direction of the first set of reference signals and the device direction of the at least one respective backscatter IoT device being consistent.

Aspect 2 is the method of aspect 1, where the plurality of sets of reference signals further include at least one second set of reference signals not corresponding to any backscatter IoT device in the one or more backscatter IoT devices.

Aspect 3 is the method of any of aspects 1 and 2, further including: receiving, from a second wireless device, an indication of a configuration for the pathloss estimation.

Aspect 4 is the method of any of aspects 1 to 3, further including: receiving, from a second wireless device, a pathloss estimation report including a plurality of pathloss measurements, each backscatter IoT device in the one or more backscatter IoT devices corresponding to at least one respective first pathloss measurement in the plurality of pathloss measurements, the plurality of pathloss measurements further including at least one second pathloss measurement not corresponding to any backscatter IoT device in the one or more backscatter IoT devices.

Aspect 5 is the method of aspect 4, further including: transmitting a query signal to a first backscatter IoT device in the one or more backscatter IoT devices based on the at least one respective first pathloss measurement corresponding to the first backscatter IoT device.

Aspect 6 is the method of any of aspects 1 to 5, further including: receiving, from a second wireless device, a plurality of reference signal measurement results, each reference signal measurement result corresponding to a respective set of reference signals in the plurality of sets of reference signals.

Aspect 7 is the method of aspect 6, where each reference signal measurement result in the plurality of reference signal measurement results includes at least one of an RSRP, an RSRQ, or an SINR.

Aspect 8 is the method of any of aspects 6 and 7, where each reference signal measurement result is an averaged result over the respective set of reference signals.

Aspect 9 is the method of any of aspects 1 to 3, further including: receiving a response from a first backscatter IoT device in the one or more backscatter IoT devices, the response being based on a query signal from a second wireless device.

Aspect 10 is the method of any of aspects 1 to 9, where each set of reference signals in the plurality of sets of reference signals is associated with a respective reference signal set ID.

Aspect 11 is the method of aspect 1, further including: configuring a first backscatter IoT device in the one or more backscatter IoT devices for second pathloss estimation; transmitting at least one set of second reference signals for the second pathloss estimation to the first backscatter IoT device; and receiving a second pathloss estimation report from the first backscatter IoT device based on the at least one set of second reference signals, the second pathloss estimation report including a second pathloss measurement of a second pathloss between the first wireless device and the first backscatter IoT device.

Aspect 12 is the method of aspect 11, further including: transmitting a continuous wave to the first backscatter IoT device, where the second pathloss estimation report is received based further on the continuous wave.

Aspect 13 is the method of any of aspects 11 and 12, further including: receiving a second reference signal measurement result from the first backscatter IoT device based on the at least one set of second reference signals.

Aspect 14 is the method of any of aspects 11 to 13, where to configure the first backscatter IoT device for the second pathloss estimation, the method further includes placing the first backscatter IoT device in a command mode.

Aspect 15 is the method of any of aspects 1 to 14, where the first wireless device is a UE or a network entity.

Aspect 16 is a method of wireless communication at a second wireless device, including receiving a plurality of sets of reference signals for pathloss estimation from a first wireless device or one or more backscatter IoT devices, each set of references signals in the plurality of sets of reference signals corresponding to a respective signal direction based on beamforming, the plurality of sets of reference signals including at least one first set of reference signals associated with the one or more backscatter IoT devices, each backscatter IoT device in the one or more backscatter IoT devices being associated with a respective device direction, each first set of reference signals in the at least one first set of reference signals corresponding to at least one respective backscatter IoT device in the one or more backscatter IoT devices based on the signal direction of the first set of reference signals and the device direction of the at least one respective backscatter IoT device being consistent; and generating a pathloss estimation report including a plurality of pathloss measurements based on the plurality of sets of reference signals, each backscatter IoT device in the one or more backscatter IoT devices corresponding to at least one respective first pathloss measurement in the plurality of pathloss measurements.

Aspect 17 is the method of aspect 16, where the plurality of sets of reference signals further include at least one second set of reference signals not corresponding to any backscatter IoT device in the one or more backscatter IoT devices, and the plurality of pathloss measurements further include at least one second pathloss measurement not corresponding to any backscatter IoT device in the one or more backscatter IoT devices.

Aspect 18 is the method of any of aspects 16 and 17, further including: receiving, from the first wireless device, an indication of a configuration for the pathloss estimation.

Aspect 19 is the method of any of aspects 16 to 18, further including: transmitting, to the first wireless device, the pathloss estimation report.

Aspect 20 is the method of any of aspects 16 to 18, further including: transmitting a query signal to a first backscatter IoT device in the one or more backscatter IoT devices based on the at least one respective first pathloss measurement corresponding to the first backscatter IoT device.

Aspect 21 is the method of any of aspects 16 to 19, further including: transmitting, to the first wireless device, a plurality of reference signal measurement results, each reference signal measurement result corresponding to a respective set of reference signals in the plurality of sets of reference signals.

Aspect 22 is the method of aspect 21, where each reference signal measurement result in the plurality of reference signal measurement results includes at least one of an RSRP, an RSRQ, or an SINR.

Aspect 23 is the method of any of aspects 21 and 22, where each reference signal measurement result is an averaged result over the respective set of reference signals.

Aspect 24 is the method of any of aspects 16 to 19 and 21 to 23, further including: receiving a response from a first backscatter IoT device in the one or more backscatter IoT devices, the response being based on a query signal from the first wireless device.

Aspect 25 is the method of any of aspects 16 to 24, where the second wireless device is a UE or a network entity.

Aspect 26 is a method of wireless communication at a second wireless device, including receiving an indication of a configuration for second pathloss estimation from a wireless device; receiving at least one set of second reference signals for the second pathloss estimation from the wireless device; and transmitting a second pathloss estimation report to the wireless device based on the at least one set of second reference signals, the second pathloss estimation report including a second pathloss measurement of a second pathloss between the wireless device and the IoT device.

Aspect 27 is the method of aspect 26, further including: receiving a continuous wave from the wireless device, where the second pathloss estimation report is transmitted based further on the continuous wave.

Aspect 28 is the method of any of aspects 26 and 27, further including: transmitting a second reference signal measurement result to the wireless device based on the at least one set of second reference signals.

Aspect 29 is the method of any of aspects 26 to 28, where the configuration for the second pathloss estimation is associated with a command mode of the IoT device.

Aspect 30 is an apparatus for wireless communication including at least one processor coupled to a memory and, based at least in part on information stored in the memory, the at least one processor is configured to implement a method as in any of aspects 1 to 29.

Aspect 31 may be combined with aspect 30 and further includes a transceiver coupled to the at least one processor.

Aspect 32 is an apparatus for wireless communication including means for implementing any of aspects 1 to 29.

Aspect 33 is a non-transitory computer-readable storage medium storing computer executable code, where the code when executed by a processor causes the processor to implement any of aspects 1 to 29.

Various aspects have been described herein. These and other aspects are within the scope of the following claims.

What is claimed is:

1. An apparatus for wireless communication at a first wireless device, comprising:
a memory; and
at least one processor coupled to the memory and, based at least in part on information stored in the memory, the at least one processor is configured to:
identify one or more backscatter Internet of Things (IoT) devices, each backscatter IoT device in the one or more backscatter IoT devices being associated with a respective device direction; and
transmit a plurality of sets of reference signals for pathloss estimation, each set of references signals in the plurality of sets of reference signals corresponding to a respective signal direction based on beamforming, the plurality of sets of reference signals comprising at least one first set of reference signals associated with the one or more backscatter IoT devices, each first set of reference signals in the at least one first set of reference signals corresponding to at least one respective backscatter IoT device in the one or more backscatter IoT devices based on the signal direction of the first set of reference signals and the device direction of the at least one respective backscatter IoT device being consistent.

2. The apparatus of claim 1, wherein the plurality of sets of reference signals further include at least one second set of reference signals not corresponding to any backscatter IoT device in the one or more backscatter IoT devices.

3. The apparatus of claim 1, the at least one processor being further configured to:
receive, from a second wireless device, an indication of a configuration for the pathloss estimation.

4. The apparatus of claim 1, the at least one processor being further configured to:
receive, from a second wireless device, a pathloss estimation report including a plurality of pathloss measurements, each backscatter IoT device in the one or more backscatter IoT devices corresponding to at least one respective first pathloss measurement in the plurality of pathloss measurements, the plurality of pathloss measurements further including at least one second pathloss measurement not corresponding to any backscatter IoT device in the one or more backscatter IoT devices.

5. The apparatus of claim 4, the at least one processor being further configured to:
transmit a query signal to a first backscatter IoT device in the one or more backscatter IoT devices based on the at least one respective first pathloss measurement corresponding to the first backscatter IoT device.

6. The apparatus of claim 1, the at least one processor being further configured to:
receive, from a second wireless device, a plurality of reference signal measurement results, each reference signal measurement result corresponding to a respective set of reference signals in the plurality of sets of reference signals.

7. The apparatus of claim 6, wherein each reference signal measurement result in the plurality of reference signal measurement results includes at least one of a reference signal received power (RSRP), a reference signal received quality (RSRQ), or a signal-to-interference-plus-noise ratio (SINR).

8. The apparatus of claim 6, wherein each reference signal measurement result is an averaged result over the respective set of reference signals.

9. The apparatus of claim 1, the at least one processor being further configured to:
receive a response from a first backscatter IoT device in the one or more backscatter IoT devices, the response being based on a query signal from a second wireless device.

10. The apparatus of claim 1, wherein each set of reference signals in the plurality of sets of reference signals is associated with a respective reference signal set identifier (ID).

11. The apparatus of claim 1, the at least one processor being further configured to:
configure a first backscatter IoT device in the one or more backscatter IoT devices for second pathloss estimation;
transmit at least one set of second reference signals for the second pathloss estimation to the first backscatter IoT device; and
receive a second pathloss estimation report from the first backscatter IoT device based on the at least one set of second reference signals, the second pathloss estimation report including a second pathloss measurement of a second pathloss between the first wireless device and the first backscatter IoT device.

12. The apparatus of claim 11, the at least one processor being further configured to:
transmit a continuous wave to the first backscatter IoT device, wherein the second pathloss estimation report is received based further on the continuous wave.

13. The apparatus of claim 11, the at least one processor being further configured to:
receive a second reference signal measurement result from the first backscatter IoT device based on the at least one set of second reference signals.

14. The apparatus of claim 11, wherein to configure the first backscatter IoT device for the second pathloss estimation, the at least one processor is further configured to place the first backscatter IoT device in a command mode.

15. The apparatus of claim 1, further comprising a transceiver coupled to the at least one processor, wherein the first wireless device is a user equipment (UE) or a network entity.

16. A method of wireless communication at a first wireless device, comprising:
identifying one or more backscatter Internet of Things (IoT) devices, each backscatter IoT device in the one or more backscatter IoT devices being associated with a respective device direction; and
transmitting a plurality of sets of reference signals for pathloss estimation, each set of references signals in the plurality of sets of reference signals corresponding to a respective signal direction based on beamforming, the plurality of sets of reference signals comprising at least one first set of reference signals associated with the one or more backscatter IoT devices, each first set of reference signals in the at least one first set of reference signals corresponding to at least one respective backscatter IoT device in the one or more backscatter IoT devices based on the signal direction of the first set of reference signals and the device direction of the at least one respective backscatter IoT device being consistent.

17. An apparatus for wireless communication at a second wireless device, comprising:
a memory; and
at least one processor coupled to the memory and, based at least in part on information stored in the memory, the at least one processor is configured to:
receive a plurality of sets of reference signals for pathloss estimation from a first wireless device or one or more one or more backscatter Internet of Things (IoT) devices, each set of references signals in the plurality of sets of reference signals corresponding to a respective signal direction based on beamforming, the plurality of sets of reference signals comprising at least one first set of reference signals associated with the one or more backscatter IoT devices, each backscatter IoT device in the one or more backscatter IoT devices being associated with a respective device direction, each first set of reference signals in the at least one first set of reference signals corresponding to at least one respective backscatter IoT device in the one or more backscatter IoT devices based on the signal direction of the first set of reference signals and the device direction of the at least one respective backscatter IoT device being consistent; and
generate a pathloss estimation report including a plurality of pathloss measurements based on the plurality of sets of reference signals, each backscatter IoT device in the one or more backscatter IoT devices corresponding to at least one respective first pathloss measurement in the plurality of pathloss measurements.

18. The apparatus of claim 17, wherein the plurality of sets of reference signals further include at least one second set of reference signals not corresponding to any backscatter IoT device in the one or more backscatter IoT devices, and the plurality of pathloss measurements further include at least one second pathloss measurement not corresponding to any backscatter IoT device in the one or more backscatter IoT devices.

19. The apparatus of claim 17, the at least one processor being further configured to:
receive, from the first wireless device, an indication of a configuration for the pathloss estimation.

20. The apparatus of claim 17, the at least one processor being further configured to:
transmit, to the first wireless device, the pathloss estimation report.

21. The apparatus of claim 17, the at least one processor being further configured to:
transmit a query signal to a first backscatter IoT device in the one or more backscatter IoT devices based on the at least one respective first pathloss measurement corresponding to the first backscatter IoT device.

22. The apparatus of claim 17, the at least one processor being further configured to:
transmit, to the first wireless device, a plurality of reference signal measurement results, each reference signal measurement result corresponding to a respective set of reference signals in the plurality of sets of reference signals.

23. The apparatus of claim 22, wherein each reference signal measurement result in the plurality of reference signal measurement results includes at least one of a reference signal received power (RSRP), a reference signal received quality (RSRQ), or a signal-to-interference-plus-noise ratio (SINR).

24. The apparatus of claim 22, wherein each reference signal measurement result is an averaged result over the respective set of reference signals.

25. The apparatus of claim 17, the at least one processor being further configured to:
receive a response from a first backscatter IoT device in the one or more backscatter IoT devices, the response being based on a query signal from the first wireless device.

26. The apparatus of claim 17, further comprising a transceiver coupled to the at least one processor, wherein the second wireless device is a user equipment (UE) or a network entity.

27. An apparatus for wireless communication at an Internet of Things (IoT) device, comprising:
a memory; and
at least one processor coupled to the memory and, based at least in part on information stored in the memory, the at least one processor is configured to:
receive an indication of a configuration for second pathloss estimation from a wireless device;
receive at least one set of second reference signals for the second pathloss estimation from the wireless device; and
transmit a second pathloss estimation report to the wireless device based on the at least one set of second reference signals, the second pathloss estimation report including a second pathloss measurement of a second pathloss between the wireless device and the IoT device.

28. The apparatus of claim 27, the at least one processor being further configured to:
receive a continuous wave from the wireless device, wherein the second pathloss estimation report is transmitted based further on the continuous wave.

29. The apparatus of claim 27, the at least one processor being further configured to:
transmit a second reference signal measurement result to the wireless device based on the at least one set of second reference signals.

30. The apparatus of claim 27, further comprising a transceiver coupled to the at least one processor, wherein the configuration for the second pathloss estimation is associated with a command mode of the IoT device.
